(19) United States
(12) Patent Application Publication
(10) Pub. No.: US 2015/0286164 A1
(43) Pub. Date: Oct. 8, 2015

(54) IMAGE FORMING APPARATUS

(71) Applicant: CANON KABUSHIKI KAISHA, Tokyo (JP)

(72) Inventors: Shinji Katagiri, Yokohama-shi (JP); Shuichi Tetsuno, Kawasaki-shi (JP); Masaru Ohno, Ebina-shi (JP); Satoshi Takami, Kawasaki-shi (JP)

(21) Appl. No.: 14/674,093

(22) Filed: Mar. 31, 2015

(30) Foreign Application Priority Data
Apr. 4, 2014 (JP) 2014-077985

(51) Int. Cl. G03G 15/16

(52) U.S. Cl. CPC G03G 15/16; G03G 15/80

(57) ABSTRACT

In an image forming apparatus, a current supply member comes into contact with a belt at a position different from a position of the transfer section in a rotational direction of the belt, and a control unit performs constant current control on the current flowing through the current supply member by setting a predetermined value to a target current value, and can change a first state in which a part of the current supplied to the current supply member flows to a ground side via a constant voltage element, and a second state in which the current supplied to the current supply member does not flow to the ground side via the constant voltage element, by maintaining the constant current control by the predetermined value.

### BACKGROUND OF THE INVENTION

1. Field of the Invention

The present invention relates to a color image forming apparatus which uses an electrophotographic process or the like.

2. Description of the Related Art

Conventionally, as an image forming apparatus such as a copying machine or a laser beam printer, an image forming apparatus having a configuration that uses an intermediate transfer member have been known. In this image forming apparatus, as a primary transfer process, by applying a voltage from a voltage power source to a primary transfer member disposed opposite to a photosensitive drum, a toner image formed on a surface of a photosensitive drum as an image carrier is transferred onto the intermediate transfer member. In a full-color printer which forms the color image consisting of a plurality of colors, by performing the primary transfer process for each color to superpose the toner images of each color one another, the toner images consisting of a plurality of colors are formed on the surface of the intermediate transfer member. Moreover, as a secondary transfer process, by applying the voltage to the secondary transfer member, the toner images of the plurality of colors formed on the intermediate transfer member surface are transferred onto a recording material surface, such as sheet. The transferred toner images are then permanently fixed to the recording material by a fixing means, thereby forming a color image.

JP 2012-98709 A discloses a configuration which performs the primary transfer, by applying the voltage to a current supply member which comes into contact with an outer circumferential surface of an intermediate transfer belt at a position away from a primary transfer section, using a belt-shaped member (hereinafter, an intermediate transfer belt) as an intermediate transfer member. Specifically, by causing the current to flow through a zener diode as a constant voltage element connected to a counter roller from the current supply member, a fixed voltage is generated in the zener diode. Thus, the potential of the intermediate transfer belt is managed by the zener diode, current is supplied to each of the plurality of photosensitive drums disposed side by side in a circumferential direction of the belt, and the toner image is primarily transferred to the intermediate transfer belt in each image forming station. According to this configuration, it is possible to reduce a high-voltage power source only for primary transfer from the apparatus configuration, and it is possible to achieve cost reduction and miniaturization of the image forming apparatus.

However, since the primary transfer voltage in each image forming station is generated by causing the current to flow from the current supply member to the zener diode, the primary transfer voltage becomes a fixed value. For that reason, when the impedance of the primary transfer section fluctuates, the primary transfer current also fluctuates, and it is difficult to control the transfer current. As a result, it is not possible to perform the transfer at a proper transfer current, and there is a risk of leading to the transfer failure. This phenomenon remarkably occurs by the excessive flow of the transfer current, especially when resistance of the intermediate transfer belt is lowered due to manufacturing tolerance, environmental variations or the like.

### SUMMARY OF THE INVENTION

An object of the present invention is to provide an image forming apparatus capable of ensuring excellent primary transferability in the image forming apparatus which performs a primary transfer by using a constant voltage element to form the potential.

In order to achieve the above-mentioned object, the image forming apparatus has the followings:

an image carrier which carries a toner image;

a rotatable endless belt which comes into contact with the image carrier to form a transfer section;

a current supply member which comes into contact with the belt at a position different from a position of the transfer section in a rotational direction of the belt to supply current to the belt;

a control unit which controls the current supplied from a power source to the current supply member;

a support member which supports the belt; and

a constant voltage element which is connected to the support member, the constant voltage element maintaining the electric potential of the transfer section, by the current supplied to the constant voltage element from the current supply member via the belt,

wherein the control unit performs constant current control on the current flowing through the current supply member by setting a predetermined value to a target current value, and the control unit can change a first state in which a part of the current supplied to the current supply member flows to a ground side via the constant voltage element, and a second state in which the current supplied to the current supply member does not flow to the ground side via the constant voltage element, by maintaining the constant current control by the predetermined value.

In order to achieve the above-mentioned object, the image forming apparatus has the followings:

an image carrier which carries a toner image;

a rotatable endless belt which comes into contact with the image carrier to form a transfer section;

a current supply member which comes into contact with the belt at a position different from a position of the transfer section in a rotational direction of the belt to supply current to the belt;

a control unit which controls the current supplied from a power source to the current supply member;

a support member which supports the belt; and

a constant voltage element which is connected to the support member,

wherein the control unit causes the current supply member to apply the current of a predetermined value to the contact portion,

the current of the predetermined value is set so that a variation state between a transfer current value flowing through the transfer section and a transfer potential formed in the transfer section includes a first variation state and a second variation state,

in the first variation state, a part of the current flowing through the contact portion flows to a ground side by the constant voltage element, and thus, the transfer current value varies in a predetermined range of variation, while the transfer potential is maintained at a predetermined potential, and

in the second variation state, the current flowing through the contact portion flows to the transfer section without flowing to the ground side by the constant voltage element, and thus, the transfer potential varies, while the transfer current value is maintained at a maximum value in the range of predetermined variation.

Further features of the present invention will become apparent from the following description of exemplary embodiments (with reference to the attached drawings).

### BRIEF DESCRIPTION OF THE DRAWINGS

FIG. 1 is a schematic diagram illustrating a schematic configuration of an image forming apparatus according to a first example of the present invention;

FIGS. 2A and 2B are schematic diagrams illustrating a configuration of a primary transfer section in the first example of the present invention;

FIGS. 3A and 3B are schematic diagrams illustrating a measurement system of circumferential resistance of an intermediate transfer belt in the first example of the present invention;

FIGS. 4A and 4B are diagrams illustrating a relation between a primary transfer current and a primary transfer potential in the first example of the present invention;

FIG. 5 is a diagram illustrating a relation between a primary transfer current and primary transfer efficiency in the first example of the present invention;

FIG. 6 is a schematic diagram illustrating another example of a configuration of the first example of the present invention;

FIG. 7 is a schematic diagram illustrating another example of the configuration of the first example of the present invention;

FIG. 8 is a schematic diagram illustrating a schematic configuration of an image forming apparatus according to a second example of the present invention;

FIG. 9 is a schematic diagram illustrating another example of the configuration of the second example of the present invention; and

FIG. 10 is a schematic diagram illustrating another example of the configuration of the second example of the present invention.

### DESCRIPTION OF THE EMBODIMENTS

Referring to the drawings, embodiments for carrying out the present invention will be exemplarily described in detail by way of examples. However, dimensions, materials, shapes, relative positions or the like of the components described in the embodiments should be appropriately changed by a configuration and various conditions of an apparatus to which the present invention is applied. That is, the scope of the present invention is not intended to be limited to the following embodiments.

### First Example

### Schematic Configuration of Image Forming Apparatus

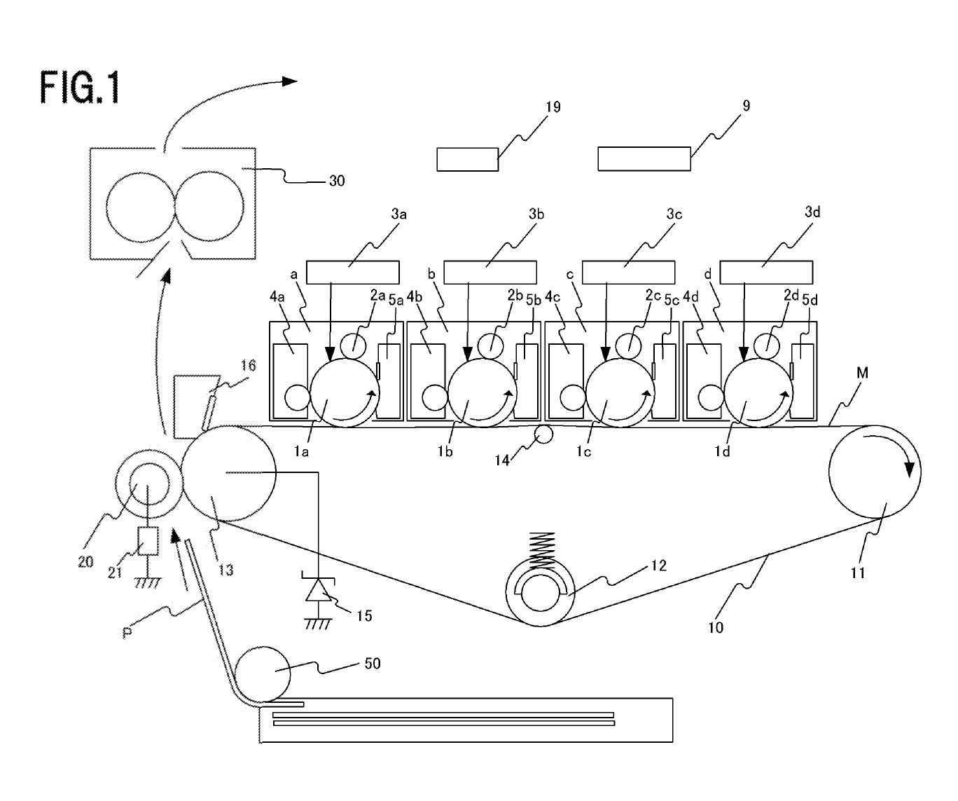

A configuration and an operation of an image forming apparatus of this example will be described referring to FIG. 1. FIG. 1 is a schematic diagram illustrating an example (laser color printer) of an image forming apparatus according to this example. The image forming apparatus of this example is a so-called tandem type printer which is provided with four image forming stations a to d. A first image forming station a forms an image of yellow (Y), a second image forming station b forms an image of magenta (M), a third image forming station c forms an image of cyan (C), and a fourth image forming station d forms an image of black (Bk), respectively. Since the configurations of each image forming station are the same except the toner colors to be stored, the description will be provided below using the first image forming station a.

The first image forming station a includes a drum-shaped electrophotographic photoreceptor (hereinafter, referred to as a photosensitive drum) 1a, a charging roller 2a serving as a charging member, a developing unit 4a and a cleaning device 5a. The photosensitive drum 1a is an image carrier which is rotationally driven at a predetermined peripheral speed (process speed) in an arrow direction to carry the toner image. The developing unit 4a is a device for developing the yellow toner on the photosensitive drum 1a which stores the yellow toner. The cleaning device 5a is a device for collecting the toner adhering to the photosensitive drum 1a. In this example, the cleaning device 5a is equipped with a cleaning blade as a cleaning member which abuts against the photosensitive drum 1a, and a waste toner box which stores the toner collected by the cleaning blade.

A CPU (control unit) 9 as a control IC of the image forming apparatus including a controller or the like starts the image forming operation by receiving an image signal to rotationally drive the photosensitive drum 1a. The photosensitive drum 1a is uniformly charged to a predetermined potential at predetermined polarity (negative polarity in this example) by the charging roller 2a in the rotational process, and receives exposure according to an image signal by an exposure means 3a. Thus, an electrostatic latent image corresponding to the yellow color component image of the objective color image is formed. Next, the electrostatic latent image is developed by the developing unit (yellow developing unit) 4a at the developing position and is visualized as a yellow toner image. Here, the regular charging polarity of the toner stored in the developing unit is negative polarity. In this is example, the electrostatic latent image is subjected to the reversal development by the toner charged to the same polarity as the charging polarity of the photosensitive drum through the charging member. However, the present invention can also be applied to an electrophotographic apparatus configured to perform the positive development of the electrostatic latent image by the toner that is charged to reversed polarity to the charging polarity of the photosensitive drum.

An intermediate transfer belt 10 is stretched (supported) by a plurality of rollers 11, 12 and 13 as a tension member (support member), and is rotationally driven substantially at the same peripheral speed as the photosensitive drum 1a, in the direction of moving in the same direction as the photosensitive drum 1a in an abutment portion abutting with the photosensitive drum 1a. The yellow toner image formed on the photosensitive drum 1a is transferred onto the intermediate transfer belt 10, in the course of passing through the abutment portion (hereinafter, referred to as a primary transfer section) between the photosensitive drum 1a and the intermediate transfer belt 10 (primary transfer). In this example, the current flows in the circumferential direction of the intermediate transfer belt 10 from a secondary transfer roller 20 as a current supply member which comes into contact with the intermediate transfer belt 10 at the time of primary transfer, and a primary transfer potential is formed in each primary transfer section of the intermediate transfer belt 10. A method of forming the primary transfer potential of this example will be described below. The primary transfer residual toner remaining on the surface of the photosensitive drum 1a is cleaned and removed by the cleaning device 5a, and thereafter, it is supplied to the image forming process after the charging.

Similarly, a second color magenta toner image, a third color cyan toner image, and a fourth color black toner image are formed by the second, third and fourth image forming stations b, c, and d, and the toner images are sequentially superposed and transferred onto the intermediate transfer belt 10. Thus, the composite color image corresponding to the objective color image is obtained on the intermediate transfer belt 10. The four color toner images on the intermediate transfer belt 10 are collectively transferred to the surface of a recording material P such as sheet fed by the sheet feeding means 50, while passing through the intermediate transfer belt 10 and a secondary transfer section formed by the secondary transfer roller 20 as a secondary transfer member (secondary transfer).

Here, as the secondary transfer roller 20, a roller having an outer diameter of 18 mm is used in which a nickel-plated steel rod having an outer diameter of 8 mm is covered with a foaming sponge body essentially consisting of NBR and epichlorohydrin rubber adjusted to volume resistance of 10⁸ Ω·cm and thickness of 5 mm. Also, the secondary transfer roller 20 comes into contact with the outer circumferential surface of the intermediate transfer belt 10 at an applied pressure of 50 N to form the secondary transfer section. The secondary transfer roller 20 is configured to perform the driven-rotation with respect to the intermediate transfer belt 10 and so as to be supplied with a constant current from the transfer power source 21, when secondarily transferring the toner on the intermediate transfer belt 10 to the recording material P.

Further, the transfer power source 21 is a high-voltage power source which is connected to the secondary transfer roller 20 to supply a secondary transfer voltage, which is output from a transformer (not illustrated), to the secondary transfer roller 20. The CPU 9 as a control unit controls the secondary transfer current applied by the transfer power source 21, by feeding back a difference between a preset control current and a monitor current as an actual output value to the transformer so that the secondary transfer current is substantially constant. The transfer power source 21 is able to provide output in a range of 100 V to 4000 V.

The recording material P carrying the four color toner images is introduced into the fixing unit 30, and the four color toner is melted and mixed by being heated and pressed there and is fixed to the recording material P. The toner remaining on the intermediate transfer belt 10 after the secondary transfer is cleaned and removed by the cleaning device 16. With the above-described operation, a full-color print image is formed.

[Configuration of Primary Transfer Section]

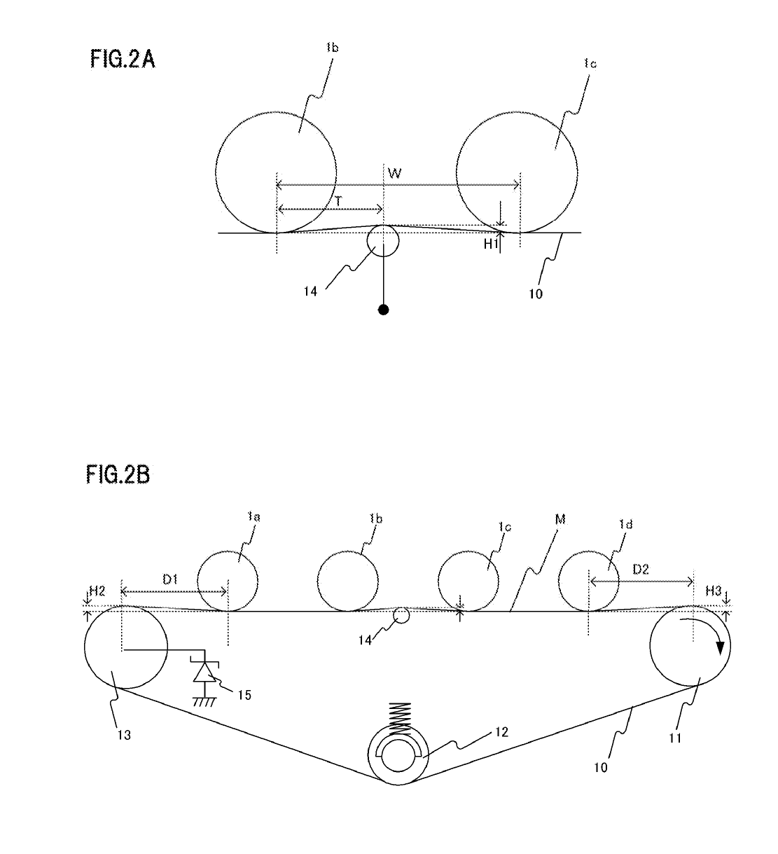

The intermediate transfer belt 10, each of the rollers 11, 12 and 13 as the tension members, the metal roller 14 and the constant voltage element 15 required to form the primary transfer potential in each primary transfer section will be described referring to FIGS. 2A and 2B. FIGS. 2A and 2B are schematic diagrams illustrating the configuration of the primary transfer section in the first example of the present invention, FIG. 2A is a diagram illustrating the arrangement of the metal roller 14, and FIG. 2B is a diagram illustrating the entire configuration of the primary transfer section.

As illustrated in FIG. 2B, at the position facing the respective image forming stations a, b, c, and d, the intermediate transfer belt 10 as an intermediate transfer member is disposed. The intermediate transfer belt 10 is an endless belt which imparts conductivity by adding a conductive agent to the resin material. The intermediate transfer belt 10 is stretched by three axes of the drive roller 11, the tension roller 12 and the secondary transfer counter roller 13 as the tension members, and is stretched with tension of the total pressure 60 N by the tension roller 12. The intermediate transfer belt 10 is rotationally driven substantially at the same peripheral speed as the photosensitive drums 1a, 1b, 1c, and 1d by the drive roller 11 that rotates by a driving source (not illustrated), in a direction (forward direction) of moving in the same direction in the abutment portion which abuts against the photosensitive drums 1a, 1b, 1c, and 1d. In this example, the primary transfer surface (surface indicated by M in FIG. 2B) which is an outer circumferential surface of the intermediate transfer belt 10 and to which the toner image is primarily transferred from the photosensitive drums 1a, 1b, 1c, and 1d is formed by the two tension members of the secondary transfer counter roller 13 and the drive roller 11.

As illustrated in FIG. 2A, in the moving direction (rotational direction) of the intermediate transfer belt 10, at a position between the photosensitive drum 1b and the photosensitive drum 1c, a metal roller 14 as a contact member coming into contact with the inner circumferential surface of the intermediate transfer belt 10 is disposed. Both end portions of the metal roller 14 are held on a frame (not illustrated) of the apparatus main body at a raised position, with respect to a horizontal plane formed by the photosensitive drums 1b and 1c and the intermediate transfer belt 10, at an intermediate position between the second image forming station b and the third image forming station c. That is, the metal roller 14 is disposed with respect to the horizontally extending intermediate transfer belt 10 so that the position of its contact portion with the intermediate transfer belt 10 is higher than the contact portion between the photosensitive drums 1b and 1c and the intermediate transfer belt 10. Thus, the tension occurs in the contact portion between the intermediate transfer belt 10 and each of the photosensitive drums 1b and 1c, which makes it possible to secure the winding amount of the intermediate transfer belt 10 to each of the photosensitive drums 1b and 1c.

The metal roller 14 is made up of an SUS rod which is nickel-plated in a straight shape having an outer diameter of 6 mm, and driven-rotates along with the rotation of the intermediate transfer belt 10. The metal roller 14 is in contact over a predetermined area in a longitudinal direction perpendicular to the moving direction of the intermediate transfer belt 10. A distance between the photosensitive drum 1b of the second image forming station b and the photosensitive drum 1c of the third image forming station c is defined as W, a distance between the photosensitive drum 1b and the metal roller 14 is defined as T, and a raised height of the metal roller 14 with respect to the intermediate transfer belt 10 is defined as H1. The distance is a distance between the adjacent axial centers in the moving direction of the intermediate transfer belt 10. In this example, W=50 mm, T=25 mm and H1=2 mm.

In addition, as illustrated in FIG. 2B, in order to secure the winding amount of the intermediate transfer belt 10 with respect to the photosensitive drums 1a and 1d in this example, the drive roller 11 and the secondary transfer counter roller 13 are raised further than the horizontal plane which is formed by the photosensitive drums 1a to 1d and the intermediate transfer belt 10. By ensuring the winding amount of the intermediate transfer belt 10 with respect to the photosensitive drums 1a and 1d, there is an effect of suppressing the transfer failure which occurs due to unstable contact between each of the photosensitive drums 1a and 1d and the intermediate transfer belt 10. A distance between the secondary transfer counter roller 13 and the photosensitive drum 1a is defined as D1, a distance between the drive roller 11 and the photosensitive drum 1d is defined as D2, a raised height of the secondary transfer counter roller 13 with respect to the intermediate transfer belt 10 is defined as H2, and a raised height of the drive roller 11 is defined as H3. In this example, D1=D2=50 mm and H2=H3=2 mm.

The intermediate transfer belt 10 used in this example has a peripheral length of 700 mm and a thickness of 90 μm, and an endless polyimide resin mixed with carbon as a conductive agent is used. In this example, although the polyimide resin is used as a material of the intermediate transfer belt 10, other materials may be used as long as they are thermoplastic resins. For example, materials such as polyester, polycarbonate, polyarylate, acrylonitrile-butadiene-styrene copolymer (ABS), polyphenylene sulfide (PPS), polyvinylidene fluoride (PVdF), and mixed resin of these materials may be used. Further, as the conductive agent, it is possible to use conductive metal oxide fine particles and an ion conductive agent other than carbon.

The intermediate transfer belt 10 of this example has the volume resistivity of 1×10⁹ Ω·cm. The volume resistivity is measured using a type UR (Type MCP-HTP12) of a ring probe in Hiresta-UP (MCP-HT450) manufactured by Mitsubishi Chemical Corporation. As measurement conditions, an indoor temperature is set to 23° C., an indoor humidity is set to 50%, an applied voltage is 100 V, and a measuring time is 10 sec. In this example, as the volume resistivity of the intermediate transfer belt 10, the volume resistivity in the range of 1×10⁷ to 10¹⁰ Ω·cm can be used. Here, the volume resistivity is a measure of conductivity as the material of the intermediate transfer belt 10, and the magnitude of circumferential resistance is important with regard to whether a belt can form a desired primary transfer potential by causing the current to actually flow in the circumferential direction.

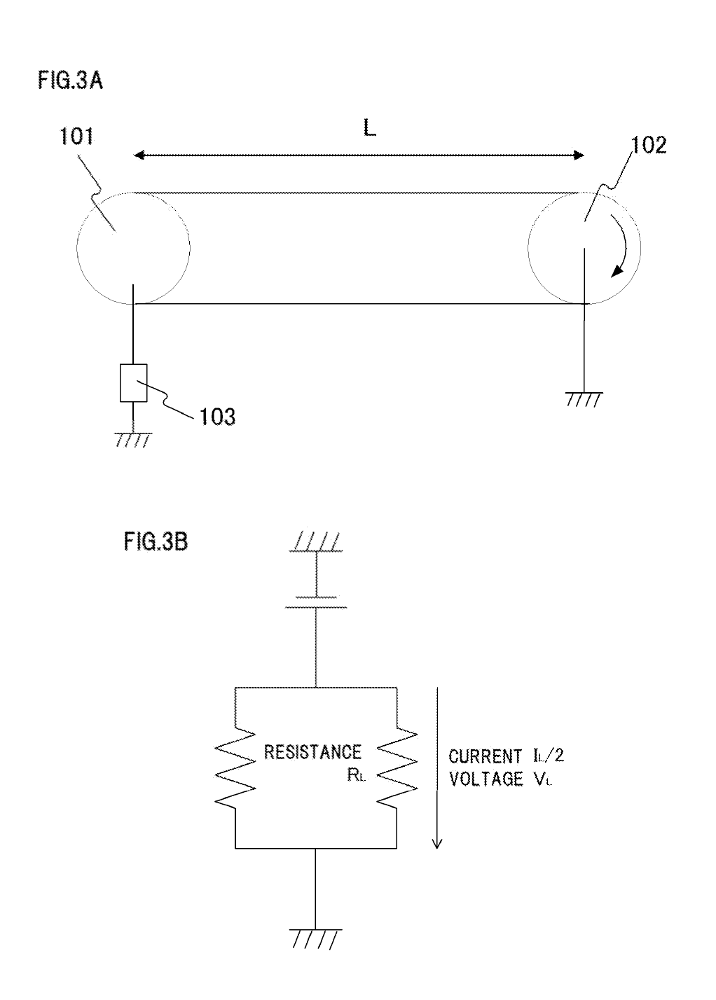

FIGS. 3A and 3B are schematic diagrams illustrating the measurement system of circumferential resistance of the intermediate transfer belt 10 in the first example of the present invention. The circumferential resistance of the intermediate transfer belt 10 was measured using a circumferential resistance measuring jig illustrated in FIG. 3A. First, a configuration of the apparatus will be described. The intermediate transfer belt 10 to be measured is stretched by the inner surface roller 101 and the drive roller 102 without slack. The inner surface roller 101 made of a metal is connected to a high-voltage power source (high-voltage power source manufactured by TREK Corp.: Model_{—}610E) 103, and the drive roller 102 is grounded. A surface of the drive roller 102 is covered with a conductive rubber having a sufficiently low resistance with respect to the intermediate transfer belt 10, and rotates so that the intermediate transfer belt 10 becomes 100 mm/sec.

Next, the measuring method will be described. A constant current I_{L} is applied to the inner surface roller 101 in a state of rotating the intermediate transfer belt 10 at 100 mm/sec by the drive roller 102, thereby monitoring the voltage V_{L} in the high-voltage power source 103 connected to the inner surface roller 101. A measurement system illustrated in FIG. 3A can be regarded as an equivalent circuit illustrated in FIG. 3B. Then, the circumferential resistance R_{L} of the intermediate transfer belt 10 in the length of the distance L (in this example, 300 mm) between the inner surface roller 101 and the drive roller 102 can be calculated by R_{L}=2V_{L}/I_{L}. The circumferential resistance is determined by converting R_{L} into the circumferential length of the intermediate transfer belt corresponding to 100 mm of the intermediate transfer belt 10. In order to apply the current from the current supply member to the photosensitive drum 1 through the intermediate transfer belt 10, the circumferential resistance is preferably 1×10⁹Ω or less.

In the configuration of this example, the intermediate transfer belt 10 having the circumferential resistance of 1×10⁶Ω determined by the above-described measuring method is used. The intermediate transfer belt 10 of this example performs the measurement at a constant current of I_{L}=5 μA, and the monitor voltage V_{L} at that time is 7.5 V. The monitor voltage V_{L} is performed in a section corresponding to one round of the intermediate transfer belt 10 and is determined from an average value of the interval measurement. In regard to R_{L}, since R_{L}=2V_{L}/I_{L}, R_{L}=2×7.5/(5×10⁻⁶)=3.0×10⁶Ω, and when converting it into the corresponding 100 mm, the circumferential resistance value is 1×10⁶Ω. In this example, the conductive belt, through which the current can flow in the circumferential direction, is used as the intermediate transfer belt 10.

As illustrated in FIG. 1, in this example, the secondary transfer counter roller 13 which forms the primary transfer surface of the intermediate transfer belt 10 with the drive roller 11 is grounded via a constant voltage element 15. The constant voltage element 15 is an element which maintains a connection target member (secondary transfer counter roller 13) at a predetermined potential, by the flow of the current from the secondary transfer roller 20 as a current supply member to the constant voltage element 15 via the intermediate transfer belt 10. A predetermined potential maintained by the constant voltage element 15 is a potential that is set so as to be able to maintain the primary transfer potential that can obtain the desired transfer efficiency in each primary transfer section. In this example, a zener diode is used as the constant voltage element 15. In addition, in the zener diode, a predetermined voltage is generated on a cathode side when a current of a certain level or more flows (hereinafter, referred to as a zener voltage). In this example, the zener voltage is set to 300 V so as to obtain desired primary transfer efficiency.

[Method of Forming Primary Transfer Potential]

In the configuration of this example, the secondary transfer power source 21, which applies a voltage to the secondary transfer member as the transfer power source, is also used as a power source for performing the primary transfer. That is, the secondary transfer power source 21 is a common transfer power source of the primary transfer and the secondary transfer and is a power source which supplies the current to the primary transfer section of the secondary transfer roller 20 and the intermediate transfer belt 10. The secondary transfer roller 20 is a current supply member in this example.

As described above, by connecting the constant voltage element 15 to the secondary transfer counter roller 13 around which the intermediate transfer belt 10 is stretched, and by supplying the current from the secondary transfer power source 21 toward the secondary transfer counter roller 13 via the intermediate transfer belt 10, a configuration which performs the primary transfer is achieved. At this time, the secondary transfer counter roller 13 becomes a potential corresponding to the constant voltage element 15, the potential becomes a starting point, the current flows in the circumferential direction of the intermediate transfer belt 10, and the primary transfer potential is and formed in each of the image forming stations a, b, c, and d. The toner on the photosensitive drums 1a, 1b, 1c, and 1d moves on the intermediate transfer belt 10 by a potential difference between the primary transfer potential and the photosensitive drum potential, and thus, the primary transfer is performed.

[Constant Current Control of Primary Transfer Process in this Example]

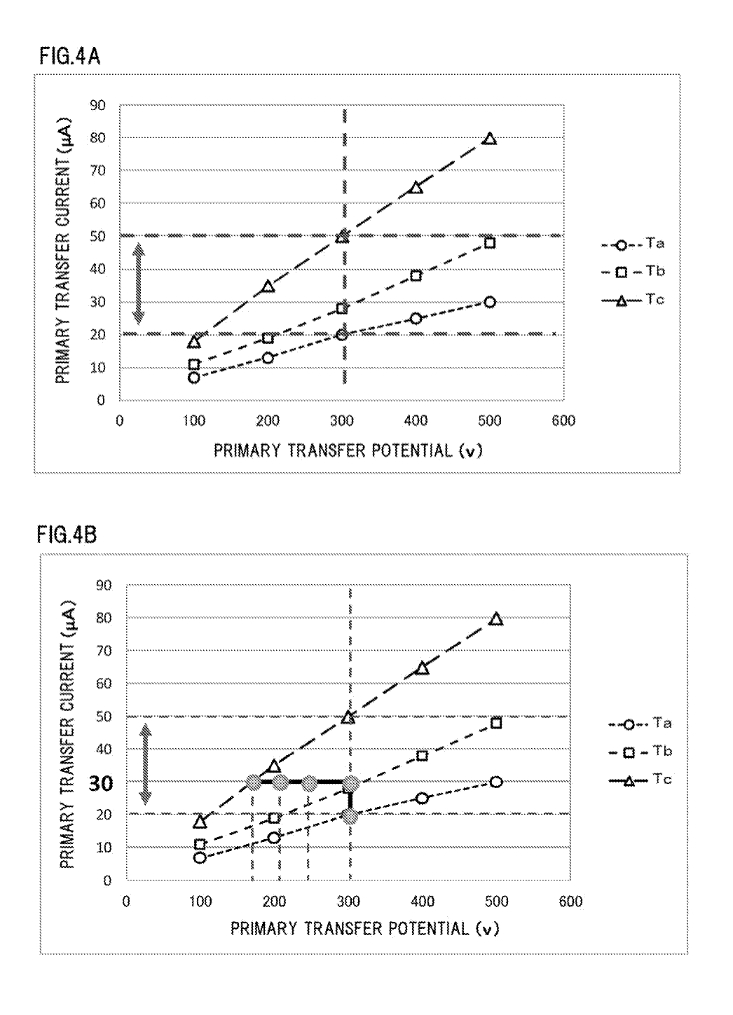

The constant current control in the primary transfer process in the first example of the present invention will be described referring to FIGS. 4A and 4B. FIGS. 4A and 4b are diagrams illustrating a relation between the primary transfer current and the primary transfer potential. This example is characterized by setting the value of the current, which is supplied from the secondary transfer roller 20 as a current supply member to the intermediate transfer belt 10, to a predetermined value so as to fall within a predetermined range even if there is a change in the primary transfer current by the impedance changes. Here, the impedance of the primary transfer section may change, due to factors of maintenance, such as the resistance of the intermediate transfer belt 10, the film thicknesses of the photosensitive drums 1a, 1b, 1c, and 1d, their manufacturing intersections, successive changes due to consumption, environmental fluctuations and replacement of parts and cartridge.

FIG. 4A is a graph illustrating a relation between the primary transfer section and the current in the case of changing the primary transfer potential. In the graph, a horizontal axis represents the potential of the primary transfer section, and a vertical axis represents the primary transfer current. In addition, the primary transfer current value in the graph represents the total value of the primary transfer current flowing through each of the photosensitive drums 1a, 1b, 1c, and 1d. Also, the respective straight lines of Ta, Tb, and Tc in the graph are different from one another in impedance of the primary transfer section, Ta represents a state of highest impedance, and Tc represents a state of lowest impedance. As the difference in the impedances of each straight line in the graph, in consideration of the resistance of the intermediate transfer belt 10, the film thicknesses of the photosensitive drums 1a, 1b, 1c, and 1d, environment or the like, a state of highest impedance is represented by Ta, and a state of lowest impedance is represented by Tc. When the potential of the primary transfer section is 300 v, the primary transfer current of 20 μA flows in the straight line Ta having the high impedance, and the current of 50 μA flows in the straight line Tc having the low impedance.

In the configuration of this example, in order to satisfy the desired transfer efficiency, the zener voltage was set to 300 V. Here, in a case where the zener voltage is 300 V, the primary transfer current in a case where the current having the magnitude of always maintaining the zener voltage is supplied to the intermediate transfer belt 10 is set to Iz.

In that case, the variation range of the primary transfer current value Iz due to variations in the impedance of the primary transfer section is 20 to 50 μA. In the primary transfer configuration of this example, since the primary transfer current is supplied from the secondary transfer roller 20 as a current supply member to the intermediate transfer belt 10, the current above the level supplied from the current supply member does not flow in the primary transfer section. Therefore, in this example, in the primary transfer and the secondary transfer, the current value supplied from the secondary transfer roller 20 as a current supply member to the intermediate transfer belt 10 was constantly controlled by performing the constant current control of the secondary transfer power source 21, and the set value I was set to 30 μA which is within the variation range of Iz.

The operation of this example will be described with reference to FIG. 4B. FIG. 4B is a diagram illustrating a constant current control of this example, and represents a relation between the primary transfer potential and the primary transfer current by a solid line, when the current value of the current supply member is 30 μA. In the case of Ta in which the impedance of the primary transfer section is highest, since 10 μA of 30 μA flows through the constant voltage element 15, the zener voltage is maintained at 300V. As a result, the primary transfer potential becomes 300V, 20 μA flows as the primary transfer current. From there, as the impedance of the primary transfer section decreases, the primary transfer current flowing in the state of the primary transfer potential of 300 V gradually increases, and on the contrary, the current flowing through the constant voltage element 15 decreases. Moreover, when the primary transfer current becomes the impedance of the primary transfer section corresponding to 30 μA (Iz=I), all the current from the current supply member becomes the primary transfer current and is controlled without using the constant voltage element 15. Thereafter, when the impedance of the primary transfer section further decreases (Iz>I), since the primary transfer potential corresponding to the constant current value I (30 μA) of the current supply member is obtained, as represented by the solid line of the graph, the potential of the primary transfer section decreases. When entering the state of Tc in which the impedance of the primary transfer section is low, the potential of the primary transfer section becomes 180 V.

For example, when the constant current value I of 50 μA flows through the primary transfer section, even if the impedance changes, the primary transfer potential is maintained at the zener voltage (300 V) by the constant voltage element 15, and the range of variation of the primary transfer current value becomes 20 to 50 μA, as illustrated in FIG. 4A. In contrast, in this example which supplies the constant current value I of 30 μA from the secondary transfer roller 20 to the intermediate transfer belt 10, the range of variation in the primary transfer current value due to changes in the impedance is 20 to 30 μA as illustrated in FIG. 4B. The maximum value (30 μA) of the range of variation of the primary transfer current value in this example becomes a value which is smaller than the maximum value (50 μA) in the range of variation of the primary transfer current Iz when the constant current value (for example, 50 μA) flows such that the zener voltage is maintained. That is, in this example, the magnitude of the constant current value I in which the secondary transfer roller 20 flows through the contact portion with the intermediate transfer belt 10 is set so that the variation in the primary transfer current values falls within a variation range having the smaller maximum value than the variation range when supplying the constant current value in which the zener voltage is always maintained.

Also, in the constant current control of 30 μA of this example, there are two types of variation states of the primary transfer current value and the primary transfer potential due to the change in impedance. One is that, since a part of the current flowing through the contact portion between the secondary transfer roller 20 and the intermediate transfer belt 10 flows to the ground side by the constant voltage element 15, while the primary transfer potential is maintained at the zener potential of 300 V, the primary transfer current value varies within a predetermined range (20 to 30 μA). Second is that, since the current flowing through the contact portion between the secondary transfer roller 20 and the intermediate transfer belt 10 flows to the primary transfer section without flowing to the ground side, while the primary transfer current value is maintained at the maximum value of 30 μA within the variation range, the primary transfer potential varies (300 V→180 V). That is, in the constant current control of this example, two variation states are represented. The two variation states include a state in which the primary transfer current varies while maintaining the zener potential (first variation state), and a state in which the primary transfer potential decreases while the primary transfer current maintains the maximum value (30 μA) (second variation state).

[Effects Obtained by Constant Current Control According to this Example]

In this example, the magnitude of the constant current value supplied from the secondary transfer roller 20 to the intermediate transfer belt 10 is set with respect to variations in the primary transfer current due to the changes in impedance so that the maximum value of the variation does not reach the maximum value of Iz. By performing the constant current control, the excessive flow of the primary transfer current is suppressed. This will be described in detail below.

Table 1 illustrates the primary transfer current, the primary transfer potential, and the primary transfer efficiency, in each state of the impedances Ta, Tb, and Tc of the primary transfer section in the present example and the comparative example. The configuration of the comparative example was configured to perform the constant voltage control of 3000 V from the secondary transfer roller 20 as a current supply member, with respect to the configuration of this example. Other configurations are the same as those in the first example. In addition, the primary transfer efficiency is calculated from the results obtained by measuring the primary transfer residual concentration by a Macbeth densitometer (manufactured by GretagMacbeth Corp.). As the measured value is great, the primary transfer residual concentration increases. Accordingly, the transfer efficiency decreases. When the primary transfer current is too low, since it is not possible to supply the current necessary for the transfer, a transfer failure occurs. When the primary transfer current is too high, since the polarity of the toner to be transferred is reversed by the excessive flow of the transfer current, the transfer failure occurs.

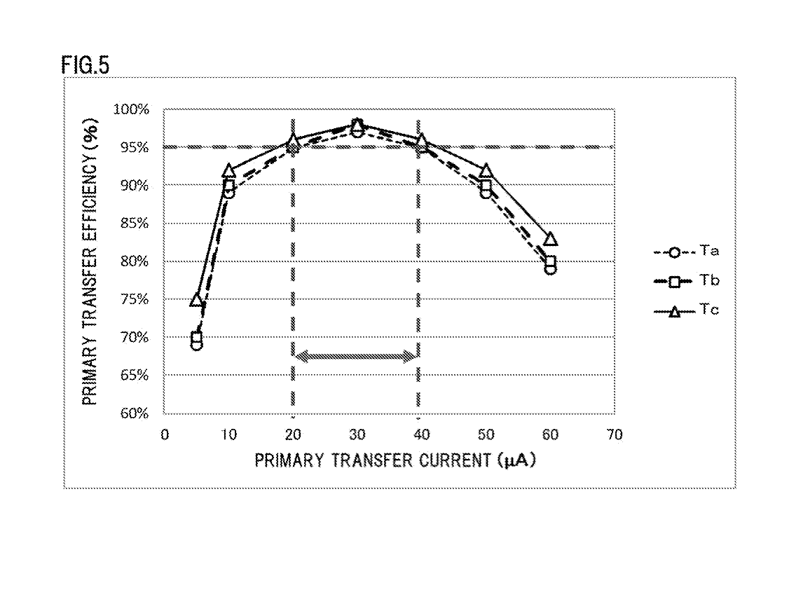

FIG. 5 is a graph illustrating the transfer efficiency in each impedance state as described above, in the configuration of this example and the comparative example. A vertical axis of the graph represents the transfer efficiency, and a horizontal axis represents the primary transfer current. In the configuration of this example and the comparative example, it is understood that a region having the excellent primary transfer efficiency (a region which achieves transfer efficiency of 95% or more) requires the primary transfer current of 20 μA to 40 μA.

TABLE 1

| | Primary transfer | Primary | Primary | Primary |
|---|---|---|---|---|
| | section | transfer | transfer | transfer |
| | impedance | potential | current | efficiency |
| Example | Ta High | 300 v | 20 μA | 95% |
| | Tb Center | 300 v | 28 μA | 98% |
| | Tc Low | 180 v | 30 μA | 98% |
| Comparative | Ta High | 300 v | 20 μA | 95% |
| example | Tb Center | 300 v | 28 μA | 98% |
| | Tc Low | 300 v | 50 μA | 90% |

This example is a constant current control which supplies the current of the constant current value of 30 μA from the current supply member to the intermediate transfer belt 10. When the impedance of the primary transfer section is high, the zener voltage is maintained at 300 V by the current flowing through the constant voltage element 15. Thus, the primary transfer potential becomes 300 V, and 20 μA flows as the primary transfer current. Similarly, even when the impedance is in the center (around the center), the primary transfer current of 28 μA flows. When the impedance is low, the current from the current supply member does not flow to the constant voltage element 15, total 30 μA becomes the primary transfer current. At this time, the potential of the primary transfer section is maintained at 180 V, it becomes a control that does not use the constant voltage element 15, and it is possible to suppress the transfer failure due to the excessive flow of the primary transfer current. As a result, in this example, since the primary transfer current falls within the scope that satisfies desired primary transfer efficiency even in the state of any impedance, it is possible to secure the excellent primary transferability.

The configuration of the comparative example controls the secondary transfer roller 20 as a current supply member at a constant voltage of 3000 V. When controlling the second transfer at a constant voltage, since the impedance of the secondary transfer section varies by the resistance of the recording material, the toner amount, the environment or the like, in some cases, the secondary transfer current varies, and more current flows. When the impedance of the primary transfer section is high and central, since the current flows through the constant voltage element 15 similarly to the example, the primary transfer potential is maintained at 300 V as the zener voltage. As a result, since the primary transfer current becomes a desired range of 20 μA to 28 μA, it is possible to secure the good primary transferability. However, even when the impedance of the primary transfer section is low, since more current flows from the secondary transfer roller 20 performing the constant voltage control, the current flows through the constant voltage element 15, and the primary transfer potential becomes 300 V equivalent to the zener voltage. Thus, the current of 50 μA flows through the primary transfer section, and the transfer efficiency decreases, which leads to a transfer failure.

As described above, in this example, the value of constant current supplied to the intermediate transfer belt 10 by the secondary transfer roller 20 is set so that the maximum value of the variation range of the primary transfer current is smaller than the maximum value of the variation range of Iz. By doing so, the excessive flow of the primary transfer current is suppressed when the impedance of the primary transfer section decreases. Thus, since it is possible to maintain an optimum primary transfer current, good primary transferability can be secured.

In this example, although the zener diode was used as the constant voltage element 15, another element may be used as long as it obtains the same effects and, for example, an element such as a varistor may be used.

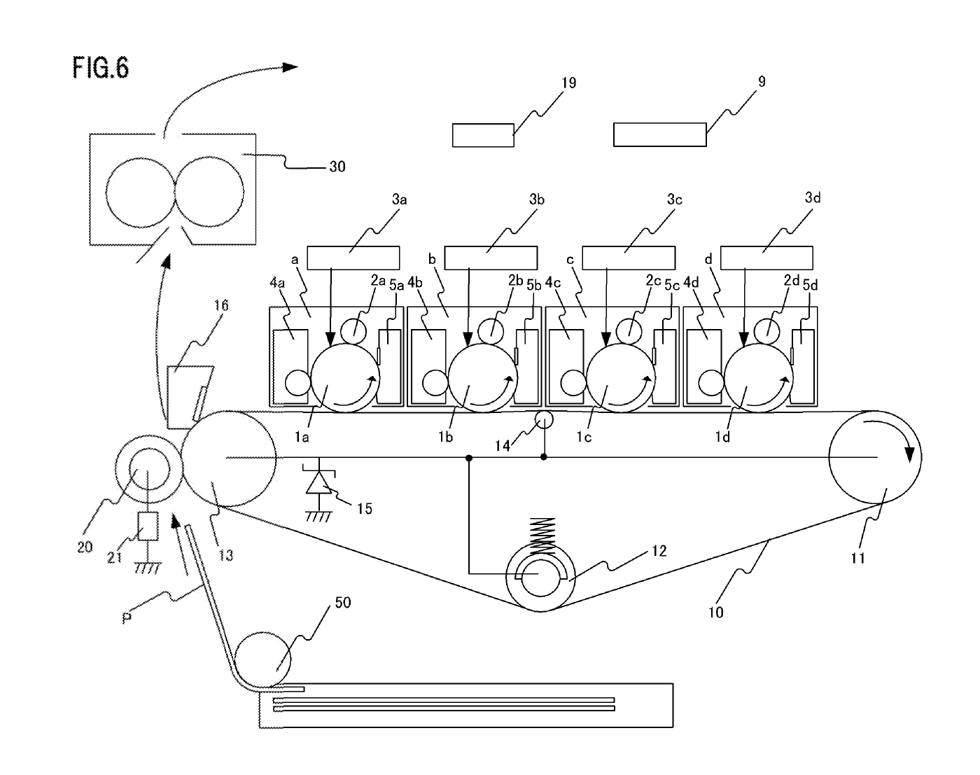

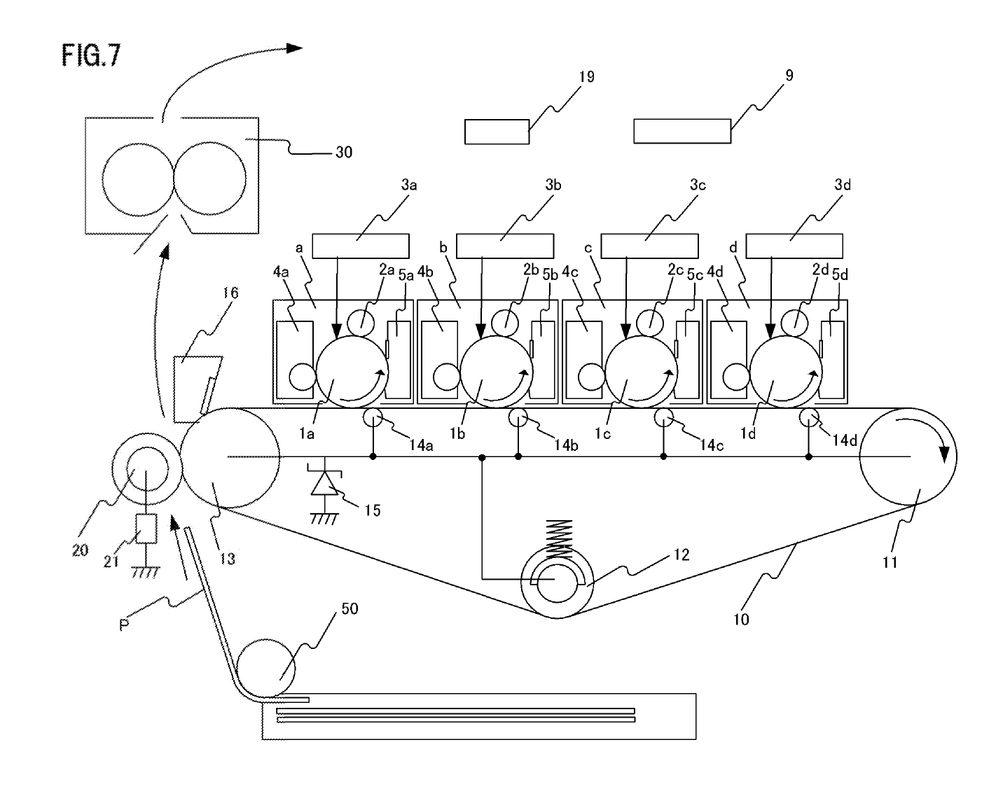

Also, in this example, although the configuration connected to only the secondary transfer counter roller 13 has been illustrated as a connection configuration of the constant voltage element 15, it is also possible to adopt other configurations without being limited to this configuration. For example, as illustrated in FIG. 6, a configuration may be adopted in which together with the secondary transfer counter roller 13, a metal roller 14 disposed between the second image forming station b and the third image forming station c, and the drive roller 11 are grounded via the constant voltage element 15. Further, as illustrated in FIG. 7, a configuration may be adopted in which the metal rollers 14a, 14b, 14c, and 14d are disposed in each of the image forming stations a to d, and these rollers are grounded together with secondary transfer counter roller 13 and the drive roller 11 via the constant voltage element 15. As described above, the intermediate transfer belt 10 is configured to be connected to the constant voltage element 15 in at least one location in each abutment portion between each photosensitive drum 1 and the intermediate transfer belt 10. By adopting such a configuration, since the current can also be supplied from the vicinity of the respective image forming stations b, c, and d, it is possible to further suppress the variation of the primary transfer current.

### Second Example

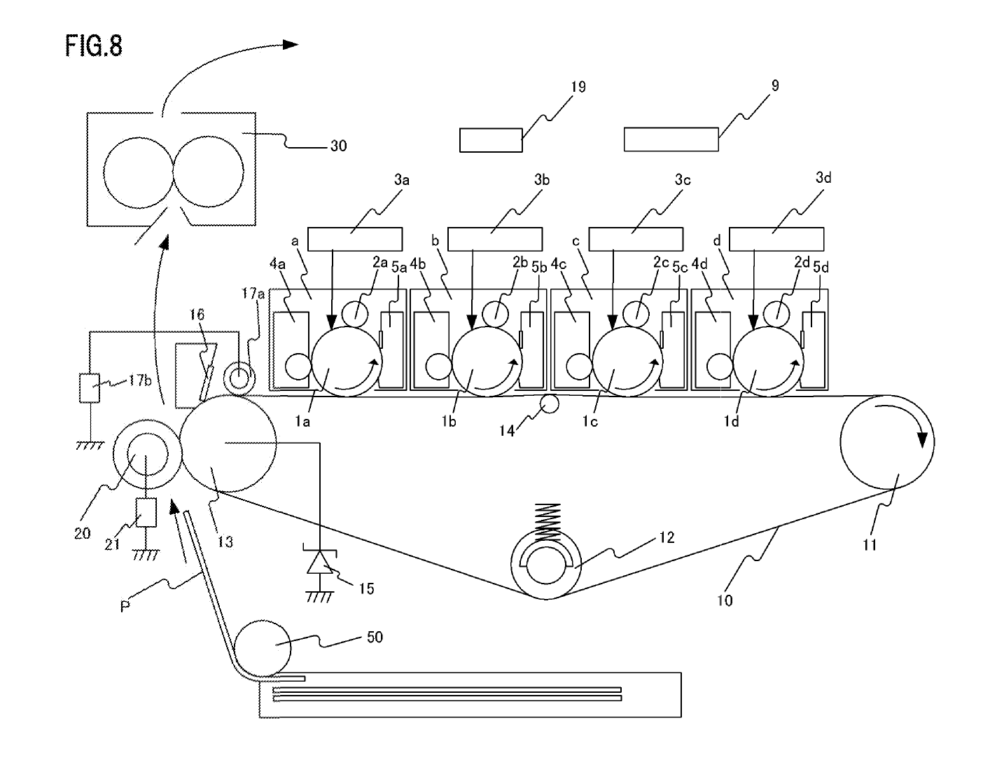

An image forming apparatus according to a second example of the present invention will be described with reference to FIG. 8. FIG. 8 is a schematic cross-sectional view of an image forming apparatus according to this example. Here, differences from the first example will be mainly described, and the same configurations as those of the first example are denoted by the same reference numerals and the description thereof will not be provided. The first example has a configuration which uses only the secondary transfer roller 20 as a current supply member to supply the current from the secondary transfer roller 20 to the intermediate transfer belt 10. In contrast, this example is characterized in that the current is also supplied to the intermediate transfer belt 10 from other conductive members, in addition to the secondary transfer roller 20 as a current supply member.

Specifically, as illustrated in FIG. 8, the image forming apparatus according to this example uses a conductive roller 17a, which is a conductive member disposed so as to come into contact with the outer circumferential surface of the intermediate transfer belt 10, as a current supply member. The conductive roller 17a comes into contact with the intermediate transfer belt 10 on a downstream side of the cleaning device 16, and serves as a current supply member to the primary transfer section. As the conductive roller 17a, an elastic roller essentially consisting of urethane rubber having volume resistivity of 10⁹ Ω·cm was used. The conductive roller 17a is pressed by a spring (not illustrated) with total pressure of 9.8 N to face the secondary transfer counter roller 13 via the intermediate transfer belt 10, and performs the driven-rotation with the rotation of the intermediate transfer belt 10. Also, the constant current of 10 μA is applied to the conductive roller 17a from the roller power source 17b to supply the current to the primary transfer section.

As described above, in this example, in addition to the secondary transfer roller 20 as a current supply member, the conductive roller 17a (second current supply member) as a conductive member is used. In the first example, the secondary transfer roller 20 has two roles. That is, the secondary transfer roller 20 has a role of applying a desired amount of current for the secondary transfer so as to satisfy the secondary transferability, and a role of applying the desired amount of current for the primary transfer to each of the photosensitive drums 1a, 1b, 1c, and 1d so as to maintain the primary transferability of the intermediate transfer belt 10 of the primary transfer section. Thus, in the first example, there was a need to supply the desired amount of current for the primary transfer and the desired amount of current for the secondary transfer only from the secondary transfer roller 20 as a current supply member.

Therefore, in this example, by also using the conductive roller 17a as a current supply member, it is also possible to satisfy the primary transferability, while setting the optimum amount of current supplied from the secondary transfer roller 20 with respect to the desired amount of current for the secondary transfer. As mentioned above, the optimum current for the primary transfer is 20 to 40 μA. That is, as long as the combined current of the conductive roller 17a and the secondary transfer roller 20 is within the range of 20 μA to 40 μA, the current required for the primary transfer is secured. Therefore, as long as a constant current of 10 μA is supplied from the conductive roller 17a, even if the current supplied from the secondary transfer roller 20 is 20 μA, a total of superposed current value becomes 30 μA, and the secondary transfer and the primary transfer are favorably performed.

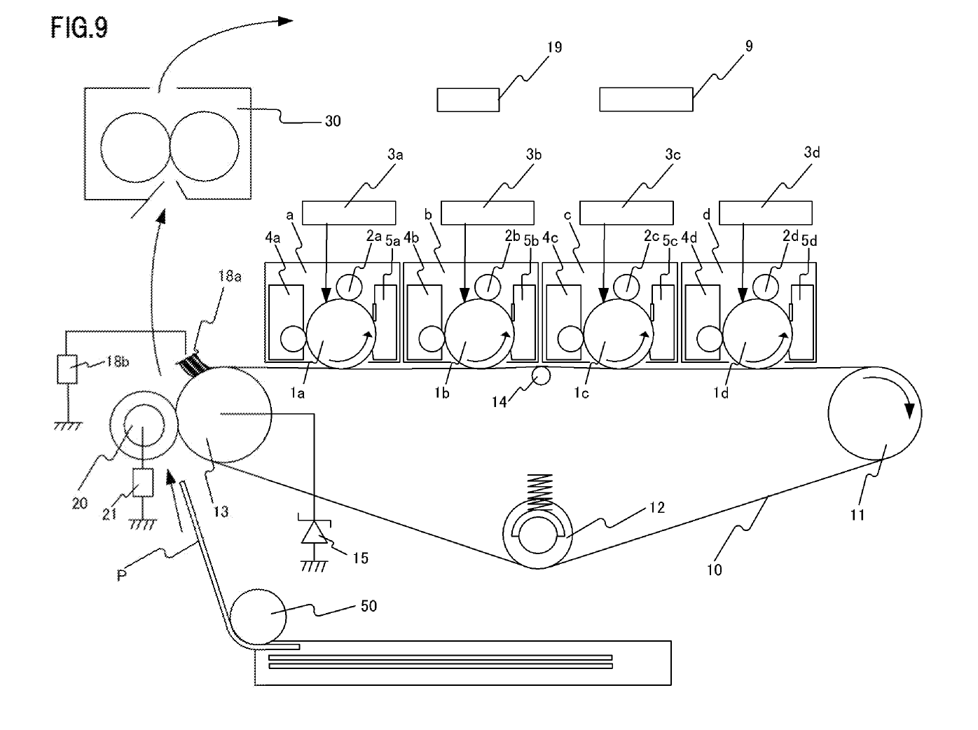

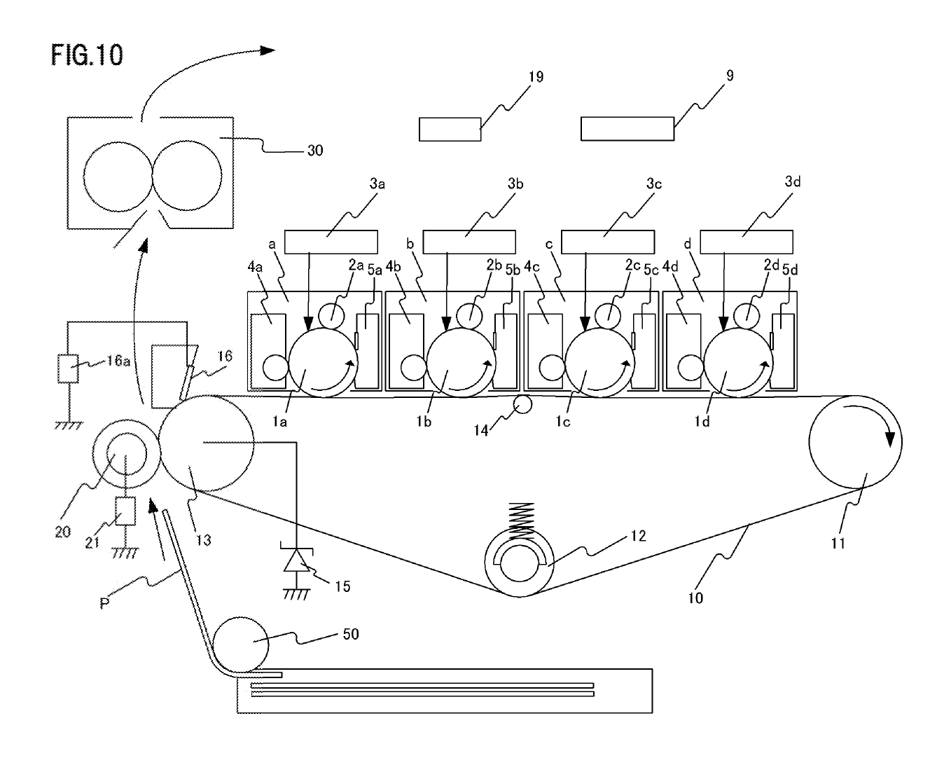

In this example, although the configuration of using the conductive roller 17a as well as the secondary transfer roller 20 as a current supply member was described, it is also possible to adopt other configurations without being limited to this configuration. For example, as illustrated in FIG. 9, even when a conductive brush 18a having a function of cleaning the toner on the intermediate transfer belt 10 is used as a current supply member, it is possible to obtain the same effects. Further, as illustrated in FIG. 10, even when the cleaning device 16 is used as a current supply member by connecting the cleaning power 16a to the cleaning device 16 illustrated in the first example, it is possible to obtain the same effect.

### Third Example

An image forming apparatus according to a third example of the present invention will be described. Here, differences from the first and second examples will be mainly described, and the same configurations as those of the first and second examples are denoted by the same reference numerals, and the descriptions thereof will not be provided. In the configurations of the first and second examples, the magnitude of the constant current value from the current supply member was set (fixed) to a predetermined constant value. In contrast, this example is characterized in that the constant current value from the current supply member is altered by the environment.

Specifically, the apparatus is equipped with a temperature-humidity sensor (temperature and humidity sensor) 19 as illustrated in FIG. 1 and the like, and sets a constant current value which is supplied to the intermediate transfer belt 10 from the current supply member, depending on the detection result. For example, in a high-temperature and high-humidity environment, there is a case where the resistance of the intermediate transfer belt 10 may be lowered, and there is a case where the impedance of the primary transfer section may be lowered. If the resistance of the intermediate transfer belt 10 is lowered, for example, when primarily transferring an isolated toner pattern interposed in a white background portion on both sides, since the transfer current flows toward the white background portion, it is not possible to supply the current to the pattern portion through which the original transfer current flows. Thus, the transferability of the isolated toner pattern may be lowered in some cases.

Therefore, in the configuration of this example, in order to prevent the transferability of the isolated toner pattern from being deteriorated, as compared to a normal environment, in the high-temperature and high-humidity environment, the constant current supplied from the current supply member to the intermediate transfer belt 10 is raised. When the low-temperature and low-humidity environment and the normal-temperature and normal-humidity environment are detected by the temperature and humidity sensor 19 or the like, the control unit 9 sets the constant current value, which is supplied from the current supply member to the intermediate transfer belt 10, to the value of 30 μA to perform the constant current control, in the same manner as in the first and second examples. Meanwhile, when detecting the high-temperature and high-humidity environment, the control unit 9 sets the constant current value supplied from the current supply member to the intermediate transfer belt 10 to 40 μA so as to be able to secure the primary transfer of the isolated pattern.

Here, as a method of raising the value of current supplied from the current supply member to the intermediate transfer belt 10, as long as the value is within the range that does not impair the secondary transferability, the constant current value of the secondary transfer roller 20 may also be raised. Also, when there is a current supply member, such as the conductive roller 17a, in addition to the secondary transfer roller 20 such as the configuration of the second example, the constant current value of the conductive roller 17a may also be raised. This makes it possible to obtain the same effects even when securing the primary transfer in the high-temperature and high-humidity environment.

Each of the above-described examples can adopt the configuration combined with each other as much as possible.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-077985, filed Apr. 4, 2014, which is hereby incorporated by reference herein in its entirety.

What is claimed is:

1. An image forming apparatus comprising:
an image carrier which carries a toner image;
a rotatable endless belt which comes into contact with the image carrier to form a transfer section;
a current supply member which comes into contact with the belt at a position different from a position of the transfer section in a rotational direction of the belt to supply current to the belt;
a control unit which controls the current supplied from a power source to the current supply member;
a support member which supports the belt; and
a constant voltage element which is connected to the support member, the constant voltage element maintaining the electric potential of the transfer section, by the current supplied to the constant voltage element from the current supply member via the belt,
wherein the control unit performs constant current control on the current flowing through the current supply member by setting a predetermined value to a target current value, and the control unit can change a first state in which a part of the current supplied to the current supply member flows to a ground side via the constant voltage element, and a second state in which the current supplied to the current supply member does not flow to the ground side via the constant voltage element, by maintaining the constant current control by the predetermined value.

2. The image forming apparatus according to claim 1, wherein the impedance of the transfer section in the first state is greater than the impedance of the transfer section in the second state.

3. The image forming apparatus according to claim 2, wherein the constant voltage element is a zener diode.

4. The image forming apparatus according to claim 2, wherein the current supply member comes into contact with the belt, at a position which is different from a position of the transfer section and at which the current supply member faces the support member via the belt.

5. The image forming apparatus according to claim 4, wherein the belt is an intermediate transfer belt to which the toner image is primarily transferred from the image carrier to transfer the toner image onto a recording material.

6. The image forming apparatus according to claim 5, wherein the current supply member comes into contact with an outer circumferential surface of the belt to secondarily transfer the toner image to the recording material from the belt by the current flowing through the contact portion.

7. An image forming apparatus comprising:
an image carrier which carries a toner image;
a rotatable endless belt which comes into contact with the image carrier to form a transfer section;
a current supply member which comes into contact with the belt at a position different from a position of the transfer section in a rotational direction of the belt to supply current to the belt;
a control unit which controls the current supplied from a power source to the current supply member;
a support member which supports the belt; and
a constant voltage element which is connected to the support member,
wherein the control unit causes the current supply member to apply the current of a predetermined value to the contact portion,
the current of the predetermined value is set so that a variation state between a transfer current value flowing through the transfer section and a transfer potential formed in the transfer section includes a first variation state and a second variation state,
in the first variation state, a part of the current flowing through the contact portion flows to a ground side by the constant voltage element, and thus, the transfer current value varies in a predetermined range of variation, while the transfer potential is maintained at a predetermined potential, and
in the second variation state, the current flowing through the contact portion flows to the transfer section without flowing to the ground side by the constant voltage element, and thus, the transfer potential varies, while the transfer current value is maintained at a maximum value in the range of predetermined variation.

8. The image forming apparatus according to claim 7, wherein a maximum value of the range of the predetermined variation is smaller than the range of the variation in a case where the current supply member supplies the current having the magnitude, in which the transfer potential formed in the transfer section is always maintained at a predetermined potential, to the contact portion with the belt.

9. The image forming apparatus according to claim 7, wherein the variation state between the transfer current value and the transfer potential successively changes from the first variation state to the second variation state.

10. The image forming apparatus according to claim 7, wherein in the second variation state, the transfer potential successively decreases.

11. The image forming apparatus according to claim 7, wherein the variation state between the transfer current value and the transfer potential changes from the first variation state to the second variation state by a decrease in the impedance of the transfer section.

12. The image forming apparatus according to claim 7, wherein the constant voltage element is a zener diode.

13. The image forming apparatus according to claim 7, wherein the current supply member comes into contact with the belt, at a position which is different from a position where the image carrier comes into contact with the belt and at which the current supply member faces the support member via the belt.

14. The image forming apparatus according to claim 7, wherein the belt is an intermediate transfer belt to which the toner image is primarily transferred from the image carrier to transfer the toner image onto a recording material.

15. The image forming apparatus according to claim 7, wherein the current supply member is a secondary transfer member which secondarily transfers the toner image to the recording material from the belt by the current flowing through the contact portion.

16. The image forming apparatus according to claim 7 further comprising:
a plurality of image carriers,
wherein the current value flowing through the contact portion is set so that a total value of each of the transfer current values of the plurality of image carriers falls within the range of the predetermined variation.

17. The image forming apparatus according to claim 16, wherein the constant voltage element is connected to the belt at the contact portion and is connected to the belt at at least one location between respective transfer sections of the plurality of image carriers.

18. The image forming apparatus according to claim 7, further comprising:
a second current supply member which comes into contact with the belt at a position different from positions where the image carrier and the current supply member come into contact with the belt,
wherein a current, which is obtained by superposing the current applied by the current supply member to the belt and the current applied by the second current supply member to the belt, flows through the transfer section.

19. The image forming apparatus according to claim 18, wherein the second current supply member is a cleaning member which cleans the surface of the belt.

20. The image forming apparatus according to claim 7, wherein the current value applied by the current supply member to the contact portion is a constant current value.

21. The image forming apparatus according to claim 7, further comprising:
a sensor which detects temperature and humidity,
wherein the value of the current applied by the current supply member to the contact portion is set, depending on the detection result of the sensor.
